(19) United States
(12) Patent Application Publication
(10) Pub. No.: US 2005/0268782 A1
(43) Pub. Date: Dec. 8, 2005

(54) Novel polyimide based mixed matrix membranes

(76) Inventors: Sudhir S. Kulkarni, Wilmington, DE (US); David J. Hasse, Bel Air, MD (US)

Correspondence Address: AIR LIQUIDE, 2700 POST OAK BOULEVARD, SUITE 1800, HOUSTON, TX, 77056, US

(21) Appl. No.: 11/091,682

(22) Filed: Mar. 28, 2005

Related U.S. Application Data
(60) Provisional application No. 60/556,868, filed on Mar. 26, 2004.

(51) Int. Cl. B01D 53/22

(52) U.S. Cl. 96/4

(57) ABSTRACT

This abstract discusses producing mixed matrix composite (MMC) membranes using polyimide polymers. Polyimide MMC membranes of the current invention are particularly useful for the production of oxygen-enriched air or nitrogen-enriched-air, for the separation of carbon dioxide from hydrocarbons or nitrogen, and the separation of helium from various streams. Membranes of polyimide polymers, such as polyimide polymers sold under the tradename P-84, are mixed with molecular sieve materials, such as SSZ-13, to make MMC membranes. The MMC membranes of the invention provide improved membrane performance compared to polymer only membranes, particularly when used to form asymmetric film membranes. The MMC films exhibit consistent permeation performance as dense film or asymmetric film membranes, and do not interact with components of the process streams, such as organic solvents. The membranes of the invention exhibit particularly surprisingly good selectivity for the fluids of interest.

### CROSS REFERENCES

This application is related to and claims the benefit of U.S. Provisional Application No. 60/556,868, filed Mar. 26, 2004, entitled “Polyimide Based Mixed Matrix Membranes”, the entire content of which is hereby incorporated by reference.

### GOVERNMENT RIGHTS

The current invention was made with Government support provided by the terms of contract No. ______, awarded by ______, thus the Government has certain rights in the invention.

### BACKGROUND

This invention relates to fluid separation membranes incorporating a molecular sieve material dispersed in a polymer.

The use of selectively gas permeable membranes to separate the components of gas mixtures is commercially very important art. Such membranes are traditionally composed of a homogeneous, usually polymeric, composition through which the components to be separated from the mixture are able to travel at different rates under a given set of driving force conditions, e.g. transmembrane pressure, and concentration gradients.

A relatively recent advance in this field utilizes mixed matrix composite (MMC) membranes. Such membranes are characterized by a heterogeneous, active gas separation layer comprising a dispersed phase of discrete particles in a continuous phase of a polymeric material. The dispersed phase particles are microporous materials that have discriminating adsorbent properties for certain size molecules. Chemical compounds of suitable size can selectively migrate through the pores of the dispersed phase particles. In a gas separation involving a mixed matrix membrane, the dispersed phase material is selected to provide separation characteristics that improve the permeability and/or selectivity performance relative to that of an exclusively continuous phase polymeric material membrane.

U.S. Pat. Nos. 4,740,219, 5,127,925, 4,925,562, 4,925,459, 5,085,676, 6,508,860, 6,626,980, and 6,663,805, which are not admitted to be prior art with respect to the present invention by their mention in this background; disclose information relevant to mixed matrix composite membranes. U.S. Pat. Nos. 4,705,540, 4,717,393, 4,880,442, and U.S. Patent Publication Nos. 20040147796, 20040107830, and 20040147796, which are not admitted to be prior art with respect to the present invention by their mention in this background, disclose polymers relevant to permeable gas separation membranes. However, these references suffer from one or more of the disadvantages discussed herein.

Permselective membranes for fluid separation are used commercially in applications such as the production of oxygen-enriched air, production of nitrogen-enriched-air for inerting and blanketing, separation of carbon dioxide from methane or nitrogen, and the separation of helium from various gas streams. It is highly desirable to use membranes, such as MMC membranes, that exhibit good permeabilities, and good permselectivities in these applications. It is particularly desirable to use asymmetric film membranes in these applications. It is also desirable to produce MMC membranes that exhibit consistent permeation performance. However, some polymers do not provide improved MMC membrane performance when used to form asymmetric film membranes. Furthermore, some polymers have shown to exhibit an interaction with components of the process streams, such as organic solvents, that can result in the loss of performance due to plasticizing the membrane or other problems.

It remains highly desirable to provide a mixed matrix gas separation membrane having molecular sieve material dispersed in a continuous polymer matrix that yield improved permeation performance, particularly when making asymmetric film membranes. It is also desirable that MMC membranes of any form show a consistent permeation performance. Finally, it is desirable to maintain permeation performance after exposure to gas mixtures with aggressive process compositions, such as compositions containing organic solvents or contaminants.

### SUMMARY

The MMC membranes of the invention satisfy the need to have mixed matrix membranes that provide improved membrane performance compared to polymer-only membranes, particularly when used to form asymmetric film mixed matrix membranes, exhibit consistent permeation performance, and do not interact with components of the process streams, such as organic solvents. The membranes of the invention exhibit surprisingly good selectivity for the fluids of interest, provide surprisingly consistent separation performance, and provide surprisingly improved separation performance as asymmetric film membranes.

The present invention provides a membrane for fluid separation containing a molecular sieve material dispersed in a continuous phase of a polyimide polymer. The polyimide polymer comprises a number of first repeating units of formula (I), described below.

The first repeating units of the polyimide polymer are of a formula (I):

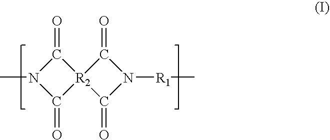

In formula (I), R₁ is a molecular segment of a formula (A), formula (B), formula (C), or mixtures of formula (A), formula (B), and formula (C), where formula (A), formula (B), and formula (C) are:

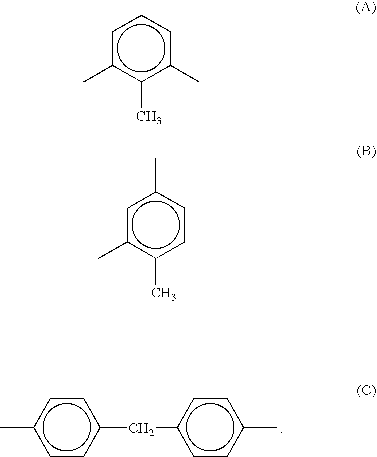

Furthermore, in formula (I), R₂ is a molecular segment of a formula (Q), formula (S), formula (T), or mixtures of formula (Q), formula (S), and formula (T), where formula (Q), formula (S), and formula (T) are:

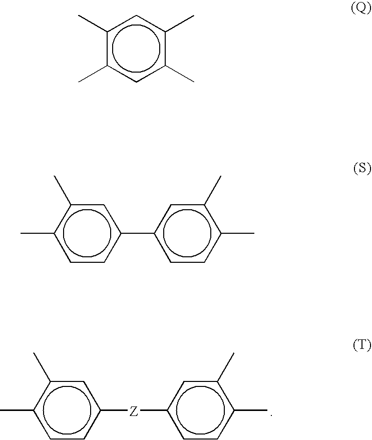

In formula (T) above, Z is a molecular segment of a formula (L), formula (M), formula (N), or mixtures of formula (L), formula (M), and/or formula (N), where formula (L), formula (M), and formula (N) are:

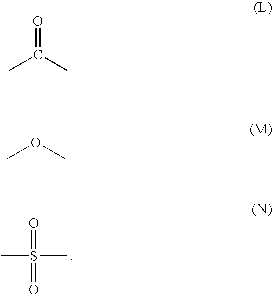

The polyimide polymer is typically, but not necessarily, a polyimide polymer sold under the tradename P84, P84HT, or mixtures thereof.

The molecular sieve materials may be, but are not limited to, CHA type molecular sieves, particularly aluminosilicate molecular sieve, silicalite molecular sieve, silico-alumino-phosphate molecular sieve, alumino-phosphate molecular sieve, carbon-based molecular sieve, and mixtures thereof. Of particular interest of molecular sieve materials, known as SSZ-13, SAPO-34, and SAPO-44.

The current invention also provides a process for producing a fluid separating membrane and the product produced by the process includes the actions of:
(a) providing a polyimide polymer comprising a number of first repeating units of formula (I), as described above;
(b) providing a molecular sieve material;
(c) synthesizing a concentrated solution, wherein the concentrated solution comprises a solvent, the polyimide polymer, and the molecular sieve material; and
(d) forming a membrane.

Furthermore, this invention includes a method of separating one or more fluids from a fluid mixture comprising the actions of:
(a) providing a fluid separation membrane of the current invention;
(b) contacting a fluid mixture with a first side of the fluid separation membrane thereby causing a preferentially permeable fluid of the fluid mixture to permeate the fluid separation membrane faster than a less preferentially permeable fluid to form a permeate fluid mixture enriched in the preferentially permeable fluid on a second side of the fluid separation membrane, and a retentate fluid mixture depleted in the preferentially permeable fluid on the first side of the fluid separation membrane, and
(c) withdrawing the permeate fluid mixture and the retentate fluid mixture separately.

These and other features, aspects, and advantages of the present invention will become better understood with regard to the following description, and appended claims.

### DESCRIPTION

The present invention provides a mixed matrix composite (MMC) membrane for fluid separation with surprisingly superior separation performance characteristics. The MMC membrane of the current invention uses a molecular sieve material and a polyimide polymer. The polyimide polymer used to make MMC membranes of the current invention contains a number of first repeating units of formula (I), which is described below. Furthermore, the present invention includes a method of producing a MMC membrane for fluid separation using the polyimide polymer of the current invention, and a process of using the membrane for fluid separation.

As used in this application, “mixed matrix membrane” or “MMC membrane” refers to a membrane that has a selectively permeable layer that comprises a continuous phase of a polymeric material and discrete particles of adsorbent material uniformly dispersed throughout the continuous phase. These particles are collectively sometimes referred to herein as the “discrete phase” or the “dispersed phase”. Thus the term “mixed matrix” is used here to designate the composite of discrete phase particles dispersed within the continuous phase.

As used in this application, a “repeating unit” refers to a molecular segment in the polymer chain backbone that repeats itself regularly along the polymer chain. In this respect, the term repeating units is meant to cover all portions of such polymers and any number of the repeating units.

As used in this application, “P84” or “P84HT” refers to polyimide polymers sold under the tradenames P84 and P84HT respectively from HP Polymers GmbH.

As used in this application, “Ultem” or “Ultem 1000” refers to a polyetherimide polymer sold under the trademark Ultem®, manufactured by GE Plastics, and available from GE Polymerland.

As used in this application, “Matrimid®” refers to a line of polyimide polymers sold under the trademark Matrimid® by Huntsman Advanced Materials.

As used in this application, “SSZ-13” refers to an aluminosilicate molecular sieve material prepared as disclosed in U.S. Pat. No. 4,544,538, the entire disclosure of which is hereby incorporated by reference.

The present invention provides a mixed matrix composite (MMC) membrane for fluid separation comprising a polyimide polymer and a molecular sieve material. The continuous phase of the mixed matrix membrane consists essentially of the polymer. By “consists essentially of” is meant that the continuous phase, in addition to polymeric material, may include non-polymer materials that do not materially affect the basic properties of the polymer. For example, the continuous phase can include preferably small proportions of fillers, additives and process aids, such as surfactant residue used to promote dispersion of the molecular sieve material in the polymer during fabrication of the membrane.

The polyimide polymer for MMC membranes of the current invention, include a number of first repeating units of formula (I):

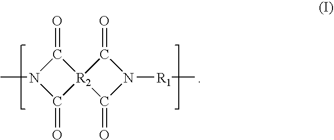

In formula (I), R₁ is a molecular segment of a formula (A), formula (B), formula (C), or mixtures of formula (A), formula (B), and formula (C), where formula (A), formula (B), and formula (C) are:

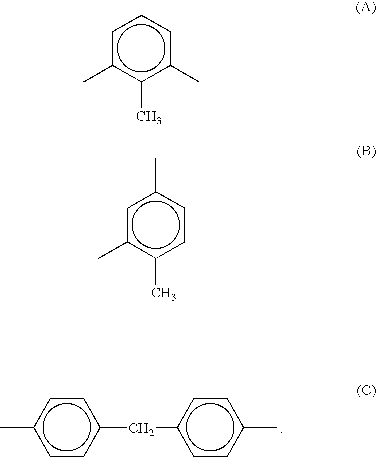

Furthermore, in formula (I), R₂ is a molecular segment of a formula (Q), formula (S), formula (T), or mixtures of formula (Q), formula (S), and formula (T), where formula (Q), formula (S), and formula (T) are:

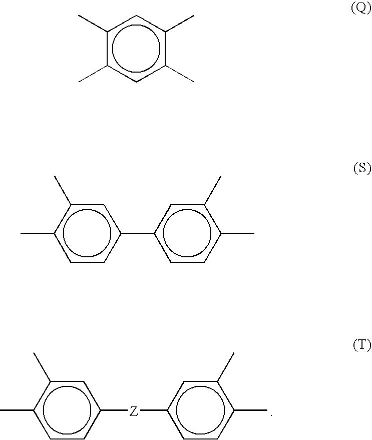

In formula (T) above, Z is a molecular segment of a formula (L), formula (M), formula (N), or mixtures of formula (L), formula (M), and/or formula (N), where formula (L), formula (M), and formula (N) are:

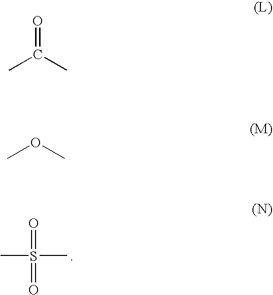

Referring to the polyimide polymer discussed above, the first repeating units may alternately be of a formula (Ia), where formula (Ia) is:

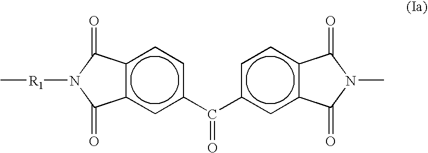

In formula (Ia), R₁ is a molecular segment having a composition of formula (A), formula (B), or formula (C), or a mixture of formula (A), formula (B), or formula (C) in the first repeating units and where formula (A), formula (B), and formula (C) are those described above.

In another alternate embodiment of formula (Ia), the R₁ in formula (Ia) has a composition of formula (A) in about 10 to about 25% of the first repeating units, formula (B) in about 55 to about 75% of the first repeating units, and formula (C) in about 20 to about 40% of the first repeating units.

In another alternate embodiment of formula (Ia), the molecular segment R₁ has a composition of formula (A) in about 16% of the first repeating units, formula (B) in about 64% of the first repeating units, and formula (C) in about 20% of the first repeating units.

Again referring to the polyimide polymer, the first repeating units may alternately be of a formula (Ib), shown below:

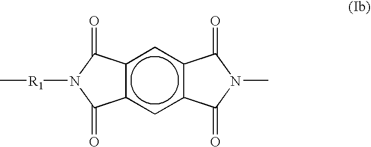

In formula (Ib), R₁ is a molecular segment having a composition of formula (A), formula (B), or mixtures of formula (A) and formula (B) in the first repeating units where formula (A), and formula (B) are described above.

Again referring to the polyimide polymer, the first repeating units may alternately be of formula (Ia), and/or formula (Ib), wherein formula (Ia) and formula (Ib) are described above.

In preferred membranes of the current invention, the polyimide polymer makes up about 20-80% of the membrane by weight (wt %). In one preferred embodiment, membranes are produced from a polyimide polymer belonging to the family of polyimide polymers sold under the tradenames P84, P84HT, or mixtures thereof. The polyimide polymers may be used to produce membranes in forms that are highly desirable. One preferred membrane form is an asymmetric film membrane.

Other components can be present in the polymer such as, processing aids, chemical and thermal stabilizers and the like, provided that they do not significantly adversely affect the separation performance of the membrane.

The polyimide polymers are a suitable molecular weight to be film forming and pliable so as to be capable of being formed into continuous films or membranes. The polyimide polymers of this invention preferably, but not necessarily, have an inherent viscosity within the range of about 0.45 to about 0.65 deciliters/gram (dl/gm), more preferably about 0.50 to about 0.62 dl/gm, and even more preferably about 0.54 to about 0.6 dl/gm.

In one preferred embodiment, the polyimide polymer used to make the mixed matrix membrane of the current invention is an annealed polyimide polymer. Annealed polyimide polymers, as used herein, are polyimide polymers treated by an annealing process as described in co-pending application Ser. No. 11/070,041, titled, “Improved Separation Membrane by Controlled Annealing of Polyimide Polymers”, filed Mar. 2, 2005, the entire disclosure of which is hereby incorporated by reference.

The dispersed phase of the membrane contains a molecular sieve material that has particular separation characteristics of flux and selectivity with respect to the components of a given gas mixture. These characteristics are largely determined by such factors as the effective pore size and framework structure. The molecular sieve separation characteristics can be chosen to be different from those of the continuous phase polymer. Usually, the separation characteristics of the molecular sieve material are selected so that overall separation performance through the mixed matrix membrane is enhanced relative to performance through a homogenous membrane of the continuous phase material. For example, a selectively gas permeable polymer might have a high flux but low selectivity in relation to a specific mixture of gases. A molecular sieve material having high selectivity for the same gases can be dispersed in the continuous phase of such polymer to produce a mixed matrix membrane having a superior combination of selectivity and flux.

The molecular sieve particle size should be small enough to provide a uniform dispersion of the particles in the suspension from which the mixed matrix membrane will be formed and also to obtain uniform distribution of the dispersed phase particles in the continuous phase of the mixed matrix membrane. The median particle size should be less than about 10 μm, preferably less than 3 μm, and more preferably less than 1 μm. Large agglomerates should be reduced to less than about 10 μm and preferably less than about 3 μm. Very fine molecular sieve particles may be made by various techniques such as by choosing appropriate synthesis conditions or by physical size reduction methods well known to those of ordinary skill in the art, such as ball milling, wet-milling, and ultrasonication.

One preferred molecular sieve material used in the mixed matrix membrane of the current invention is described in U.S. Pat. No. 6,626,980, which is fully incorporated herein by this reference. This type of molecular sieve material is iso-structural with the mineral zeolite known as chabazite. That is, they are characterized by the chabazite framework structure designated as CHA by Atlas of Zeolite Structure Types, W. M. Meier, DH Olson and Ch. Baerlocher, Zeolites 1996, 17 (A1-A6), 1-230 (hereinafter “IZA”). This molecular sieve type derives its name from the structure of a naturally occurring mineral with the approximate unit cell formula Ca₆Al₁₂Si₂₄O₇₂. The chabazite type (CHA) molecular sieves are distinguished by channels based on 8-member rings with about 3.8 Å×3.8 Å (0.38 nm×0.38 nm) dimensions.

Illustrative examples of CHA type molecular sieves suitable for use in this invention include SSZ-13, SAPO-34, and SAPO-44. SSZ-13 is an aluminosilicate molecular sieve material prepared as disclosed in U.S. Pat. No. 4,544,538, the entire disclosure of which is hereby incorporated by reference. Generally, SSZ-13 is a zeolite having a mole ratio of an oxide selected from silicon oxide, germanium oxide, and mixtures thereof to an oxide selected from aluminum oxide, gallium oxide, and mixtures thereof greater than about 5:1 and having the x-ray diffraction lines of Table 1 of U.S. Pat. No. 4,544,538. The zeolite further has a composition, as synthesized and in the anhydrous state, in terms of mole ratios of oxides as follows: (0.5 to 1.4) R₂O: (0 to 0.50) M₂O: W₂O₃: (greater than 5) YO₂ wherein M is an alkali metal cation, W is selected from aluminum, gallium, and mixtures thereof, Y is selected from silicon, germanium and mixtures thereof, and R is an organic cation. The organic R is removed typically by calcination at about 280-500° C. As used in this application, “calcinated SSZ-13” refers an SSZ-13 sieve material with organic R removed. SSZ-13 zeolites can have a YO₂: W₂O₃ mole ratio greater than about 5:1. As prepared, the silica:alumina mole ratio is typically in the range of 8:1 to about 50:1. Higher mole ratios can be obtained by varying the relative ratios of reactants. Higher mole ratios can also be obtained by treating the zeolite with chelating agents or acids to extract aluminum from the zeolite lattice. The silica:alumina mole ratio can also be increased by using silicon and carbon halides and similar compounds. Preferably, SSZ-13 is an aluminosilicate in which W is aluminum and Y is silicon.

Some preferred embodiments remove the alkali metal cation from SSZ-13 and to replace it with hydrogen, ammonium or other desired metal ion. Ion exchange can occur after the organic moiety R is removed, usually by calcination. The hydrogen and sodium forms of SSZ-13, referred to herein respectively as H-SSZ-13 and Na-SSZ-13, are two preferred SSZ-13 molecular sieve materials for use in this invention. H-SSZ-13 can be formed from Na-SSZ-13 by hydrogen exchange or preferably by ammonium exchange followed by heating to about 280400° C., or in some embodiments, heating to 400-500° C. One sample of H-SSZ-13 was found to have a Si/Al ratio of about 20-24 and Na/Al ratio of less than about 0.3 by electron spectroscopy chemical application (“ESCA”) or inductively coupled plasma (“ICP”) analysis.

The description and method of preparation of the silicoaluminophosphate molecular sieve materials SAPO-34 and SAPO-44 are found in U.S. Pat. No. 4,440,871, which is hereby incorporated herein by reference. The structure of these molecular sieves is reported by Ashtekar et al., (Journal of Physical Chemistry, V98, N18, May 5, 1994, p. 4878) to be that of the CHA type. SAPO-34 is also identified as having a CHA type structure in the Journal of the American Chemical Society, 106, p. 6092-93 (1984).

In one aspect of this invention, the molecular sieve can be bonded to the continuous phase polymer. The bond provides better adhesion and an interface substantially free of gaps between the molecular sieve particles and the polymer. Absence of gaps at the interface prevents mobile species migrating through the membrane from bypassing the molecular sieve material particles or the polymer. This assures maximum selectivity and consistent performance among different samples of the same molecular sieve/polymer composition.

Bonding of the molecular sieve to the polymer utilizes a suitable binder such as a silane. Any material that effectively bonds the polymer to the surface of the molecular sieve should be suitable as a binder provided the material does not block or hinder migrating species from entering or leaving the pores. Preferably the binder is reactive with both the molecular sieve and the polymer. The molecular sieve can be pretreated with the binder prior to mixing with the polymer, for example, by contacting the molecular sieve material with a solution of a binder dissolved in an appropriate solvent. This step is sometimes referred to as “sizing” the molecular sieve material. Such sizing typically involves heating and holding the molecular sieve dispersed in the binder solution for a duration effective to react the binder with silanol groups on the molecular sieve. Alternatively, the binder can be added to the dispersion of the molecular sieve particles in polymer solution. In such case the binder can be sized to the molecular sieve while also reacting the binder to the polymer. Bonding of the molecular sieve to the polymer is completed by reacting functional groups of the binder on the sized molecular sieve with the polymer. Thus, as used in this application, “sized SSZ-13” refers an SSZ-13 sieve material that is treated with a binder as described above. Sizing is disclosed in U.S. Pat. No. 6,626,980, the entire disclosure of which is hereby incorporated by reference.

Monofunctional organosilicon compounds disclosed in U.S. Pat. No. 6,508,860, the entire disclosure of which is hereby incorporated by reference, are one group of preferred binders. Representative of such monofunctional organosilicon compounds are 3-aminopropyl dimethylethoxy silane (APDMS), 3-isocyanatopropyl dimethylchlorosilane (ICDMS), 3-aminopropyl diisopropylethoxy silane (ADIPS) and mixtures thereof. Thus, as used in this application, “silanated SSZ-13” refers an SSZ-13 sieve material that is treated as described above with a monofunctional organosilicon compound as a binder.

In another aspect of the invention, a molecular sieve material that has been pretreated by a washing method is used. The washing method generally includes treatment by such methods as soaking, steaming, and acidifying prior to adding the molecular sieve material to the suspension. Tests have shown that using washed sieve material provides a surprising improvement in both the permeability and selectivity of MMC membranes. Washed molecular sieve material is commercially available from some molecular sieve material suppliers, such as Chevron Research & Technology Company. Thus, as used in this application, “washed SSZ-13” refers an SSZ-13 sieve material that has been treated by a washing method. One preferred membrane comprises a washed molecular sieve material and a polyimide polymer of the current invention. Preferred washed sieve materials include a washed Na-SSZ-13 molecular sieve material, a washed H-SSZ-13 molecular sieve material, or a mixture of the washed Na-SSZ-13 and washed H-SSZ-13 molecular sieve materials.

The mixed matrix membrane of this invention is formed by uniformly dispersing the molecular sieve particles in the continuous phase polyimide polymer of formula I. This can be accomplished by dissolving the polymer in a suitable solvent and then adding the molecular sieve material, either directly as dry particulates or as a slurry, to the liquid polymer solution to form a concentrated suspension. The slurry medium can be a solvent for the polymer that is either the same or different from that used in polymer solution. If the slurry medium is not a solvent for the polymer, it should be compatible (i.e., miscible) with the polymer solution solvent and it should be added in a sufficiently small amount that will not cause the polymer to precipitate from solution. Agitation and heat may be applied to dissolve the polymer more rapidly or to increase the solubility of the polymer in the solvent. The temperature of the polymer solvent should not be raised so high that the polymer or molecular sieve material is adversely affected. Preferably, solvent temperature during the dissolving step should be about 25 to about 100° C.

The polymer solution should be agitated to maintain a substantially uniform dispersion prior to mixing the slurry with the polymer solution. Agitation called for by this process can employ any conventional high shear rate unit operation such as ultrasonic mixing, ball milling, mechanical stirring with an agitator and recirculating the solution or slurry at high flow through or around a containment vessel.

In another aspect of the invention, the concentrated suspension can be treated with an electrostatically stabilizing additive, referred to herein as an “electrostabilizing additive” to form a stabilized suspension from which the MMC membrane is formed. The electrostabilizing additive may be added to the concentrated suspension while the suspension is agitated.

The electrostatically stabilizing method provides a surprising improvement in the permeability, selectivity, mechanical strength, and consistency of the permeability and selectivity of MMC membranes. This electrostabilizing method is disclosed in co-pending U.S. application Ser. No. ______, titled, “Novel Method of Making Mixed Matrix Membranes Using Electrostatically Stabilized Suspensions”, filed the same day as this application, and the entire disclosure of which is hereby incorporated by reference. Thus, as used in this application, “electrostabilized suspension” refers to a concentrated suspension for forming membranes that has been stabilized by the method of the above application.

Various membrane structures can be formed by conventional techniques known to one of ordinary skill in the art. By way of example, the suspension can be sprayed, cast with a doctor knife, or a substrate can be dipped into the suspension. Typical solvent removal techniques include ventilating the atmosphere above the forming membrane with a diluent gas and drawing a vacuum. Another solvent removal technique calls for immersing the dispersion in a non-solvent for the polymer that is miscible with the solvent of the polymer solution. Optionally, the atmosphere or non-solvent into which the dispersion is immersed and/or the substrate can be heated to facilitate removal of the solvent. When the membrane is substantially free of solvent, it can be detached from the substrate to form a self-supporting structure or the membrane can be left in contact with a supportive substrate to form an integral composite assembly. In such a composite, preferably the substrate is porous or permeable to gaseous components that the membrane is intended to separate. Further optional fabrication steps include washing the membrane in a bath of an appropriate liquid to extract residual solvent and other foreign matter from the membrane and drying the washed membrane to remove residual liquid.

One preferred embodiment of the current invention forms an asymmetric film membrane. As used herein, an “asymmetric film membrane” or “asymmetric membrane” refers to a fluid separation membrane that typically, but not necessarily, comprises a dense separating layer supported on an anisotropic substrate of a graded porosity that are generally prepared in one step. As used herein, an “asymmetric film” refers to the dense separation layer of the asymmetric film membrane. Methods of forming asymmetric film membranes are known by one of ordinary skill in the art. One preferred method of making asymmetric film membranes is described in detail in U.S. Pat. No. 5,468,430, the entire disclosure of which is hereby incorporated by reference.

The ratio of molecular sieve material to polymer in the membrane can be within a broad range. Enough continuous phase should be present to maintain the integrity of the mixed matrix composite. For this reason, the molecular sieve material usually constitutes at most about 100 weight parts of molecular sieve per 100 weight parts of polymer (or 100 wt. % molecular sieve based on polymer, also referred to as “wt. % bop”). It is desirable to maintain the respective concentration of polymer in solution and molecular sieve particles in suspension at values which render these materials free flowing and manageable for forming the membrane. Preferably, the molecular sieve material in the membrane should be about 5 wt. % bop to about 50 wt. % bop, and more preferably about 10 to about 30 wt. % bop.

The solvent utilized for dissolving the polymer to form the suspension medium and for dispersing the molecular sieve particles in suspension is chosen primarily for its ability to completely dissolve the polymer and for ease of solvent removal in the membrane formation steps. Common organic solvents, including most amide solvents that are typically used for the formation of polymeric membranes, such as N-methylpyrrolidone (“NMP”), N,N-dimethyl acetamide (“DMAC”), or highly polar solvents such as m-cresol. Representative solvents for use according to this invention also include tetramethylenesulfone (“TMS”), dioxane, toluene, acetone, and mixtures thereof.

The current invention includes a method of separating one or more fluids from a fluid mixture comprising the steps of:
(a) providing a fluid separation membrane of the current invention; and
(b) contacting a fluid mixture with a first side of the fluid separation membrane thereby causing a preferentially permeable fluid of the fluid mixture to permeate the fluid separation membrane faster than a less preferentially permeable fluid to form a permeate fluid mixture enriched in the preferentially permeable fluid on a second side of the fluid separation membrane, and a retentate fluid mixture depleted in the preferentially permeable fluid on the first side of the fluid separation membrane, and (c) withdrawing the permeate fluid mixture and the retentate fluid mixture separately.

The novel MMC membranes of the current invention can operate under a wide range of conditions and thus are suitable for use in processing feed streams from a diverse range of sources. For example, membranes of the current invention are particularly suitable for separating oxygen, carbon dioxide, or helium from nitrogen, or streams containing hydrocarbons. The membranes resist plasticizing, and thus are also suitable for use where the process stream contains materials that interact with membrane polymers, such as organic solvents. Thus, one preferred method feeds a fluid mixture to the fluid separation membrane that comprises carbon dioxide and methane. Another preferred method feeds a fluid mixture to the fluid separation membrane that comprises helium and a hydrocarbon. Another preferred embodiment separate oxygen from nitrogen.

MMC film membranes prepared from the polyimide polymers of the current invention show surprisingly enhanced permeation performance, particularly selectivity, relative to neat dense film membranes made of the same polymer. The selectivity of MMC membranes made with the polyimide polymers, particularly asymmetric membranes, is particularly suitable for the separation of oxygen and nitrogen, and the separation of carbon dioxide from nitrogen or hydrocarbon streams. Furthermore, the selectivity of MMC membranes of the current invention are surprisingly good for the separation of helium and nitrogen. Preferred embodiments are also resistant to interaction with streams containing hydrocarbons or contaminants that reduce the separation performance of the membrane. Finally, the separation performance of MMC membranes, particularly asymmetric MMC membranes, of the current invention show surprisingly consistent separation performance between various MMC film samples. Thus, MMC membranes of the current invention are well suited for a number of process applications, and particularly for use in oxygen/nitrogen production processes, and natural gas processes.

### EXAMPLES

This invention is now illustrated by examples of certain representative, non-limiting embodiments thereof.

Dense Films

Neat and MMC P84 dense films with approximately 15% SSZ-13 loading were tested with O₂, CO₂, He, and N₂ pure gases at approximately 50 psi transmembrane pressure and temperatures of 35-50° C. Scanning electron microscope (SEM) showed good adhesion between the APDMS silanated SSZ-13 particles and the P84 matrix. As shown in Table 1, reproducible improvements were seen for MMC dense film membrane coupons.

TABLE 1
Pure Gas Permeabilities for Neat and MMC P84 Dense Films

| | | | Permeability Barrer | | | | Selectivity | | |
|---|---|---|---|---|---|---|---|---|---|
| P84 | Temp. C. | Sample # | O₂ | N₂ | CO₂ | He | O₂/N₂ | CO₂/N₂ | He/N₂ |
| Neat | 35 | 1 | 0.48 | 0.070 | 1.80 | 9.4 | 6.92 | 25.9 | 136 |
| | | 2 | 0.37 | 0.055 | | | 6.71 | | |
| | | 3 | 0.36, | 0.05, | | | ˜6.8 | | |
| | | | 0.47 | 0.07 | | | | | |
| | | 4 | 0.41 | 0.059 | 1.50 | 7.7 | 6.84 | 25.3 | 130 |
| | | 5 | 0.38 | 0.060 | 1.49 | 7.3 | 6.42 | 25.0 | 122 |
| | | Avg | 0.41 | 0.061 | 1.60 | 8.1 | 6.72 | 25.4 | 129 |
| +15% | 35 | 6 | 0.47 | 0.065 | 1.95 | 11.9 | 7.27 | 30.0 | 183 |
| HSSZ13 | | 7 | 0.48 | 0.059 | 1.77 | 12.2 | 8.15 | 30.3 | 209 |
| (2814-03) | | 8 | 0.51 | 0.069 | 2.09 | 13.5 | 7.37 | 30.5 | 197 |
| | | 9 | 0.49 | 0.068 | 1.89 | 12.1 | 7.27 | 27.9 | 178 |
| | | Avg | 0.49 | 0.065 | 1.93 | 12.4 | 7.51 | 29.7 | 192 |
| | | Increase | 19% | 6% | 21% | 53% | 12% | 17% | 48% |
| Neat | 50 | 10 | | 0.112 | 2.10 | 13.4 | | 18.8 | 120 |
| | | 11 | | 0.094 | 1.98 | 10.3 | | 21.1 | 109 |
| | | 12 | | 0.100 | 1.96 | 9.9 | | 19.7 | 99 |
| | | Avg | | 0.102 | 2.01 | 11.2 | | 19.8 | 109 |
| +15% | 50 | 13 | | 0.107 | 3.08 | 13.1 | | 28.8 | 122 |
| HSSZ13 | | 14 | | 0.072 | 2.43 | 15.9 | | 33.8 | 221 |
| (2814-03) | | 15 | | 0.103 | 2.62 | 17.9 | | 25.5 | 174 |
| | | 16 | | 0.096 | 2.37 | 15.9 | | 24.8 | 166 |
| | | Avg | | 0.094 | 2.63 | 15.7 | | 28.2 | 171 |
| | | Increase | | −7% | 30% | 40% | | 42% | 56% |

The P84 MMC dense film membranes showed an appreciable improvement in permeation performance over the neat P84 dense film membranes. Surprisingly, the P84 MMC dense film membranes also showed very consistent permeation performance. By contrast, MMC dense film membranes made with Ultem polymer, which represents the state of the art prior to the current invention, typically show a larger degree of variation in permeation data.

Asymmetric Films

Several prior art examples of asymmetric films were made with Matrimid polymer and SSZ-13 molecular sieve material. The asymmetric membranes were case from control films using manufacturing sheath solutions as well as zeolite containing suspensions in the same solutions. The casting parameters were kept constant. The different suspensions tested different concepts in promoting adhesion at the interface between the zeolite and the Matrimid matrix of the asymmetric film. In two cases, silanated SSZ-13 was coated with a polymer sizing, one of Matrimid and the other Ultem. A SAPO sample was also included in this study. Permeation results are shown in Table 2.

TABLE 2
Matrimid Polymer Asymmetric Film Results

| | | Actual | Actual |
|---|---|---|---|
| Membrane Film | Test | O₂ GPU | O₂/N₂ |
| Sheath solution | Pure/35° C. | 2-8 | 4-5.5 |
| H-SSZ-13 | Pure/35° C. | 12.3 | 5.72 |
| Matrimid sized, | | | |
| Silanated with | | | |
| UItem = 0.15 | | | |
| H-SSZ-13 | Pure/35° C. | 19.3 | 6.1 |
| UItem sized, | | | |
| Silanated with | | | |
| Matrimid = 0.16 | | | |
| SAPO 44 | Air/20° C. | 3-5 | 6.95 |
| Silanated with | | | |
| Matrimid = 0.15 | | | |

By comparison, Matrimid dense films have a selectivity of about 6.3 to about 6.8 at 35° C. and about 6.9 to about 7.1 at ambient temperature. Thus, Matrimid asymmetric mixed matrix films have selectivities that are about 0 to about 15% less than the neat dense film values. Similar results were found for MMC asymmetric films versus neat dense films based on Ultem polymer.

Asymmetric films typical of the current invention were cast from a solution of 22-24% P84 in NMP with 15% (wt, bop) of SSZ-13. The films were dehydrated by a simple one-rinse i-PrOH exposure, air-dried and post-treated to seal defects with 2% 2577 in iso-octane. The film preparation conditions are listed in Table 3.

TABLE 3
Asymmetric MMC Film Preparation Parameters

| | Zeolite | | % P84 | Plate ° C./ | |
|---|---|---|---|---|---|
| Sample | dried 180 C. | % zeolite | soln | knife mils | Drying ° C. |
| 41-1 | SSZ-13 | 15% | 24 | 92/15 | 135 |
| 41-2 | C2814-08 | 15% | 24 | 92/15 | 90 |
| 41-3 | | 15% | 24 | 92/15 | 90 |
| 41-4 | | 15% | 24 | 92/15 | 135 |
| 48-A-AS | Ultem-sized | 15% | 21 | 92/15 | 90 |
| | SSZ-13 | | | | |
| 59-D-AS | SAPO-34 | 15.1% | 19.4 | 95/30 | 75 |
| | decanted | | | | |
| 59-E-AS | SSZ-13 | 14.9% | 22.7 | 102/15 | 75 |
| | w/w 59-1 | | | | |
| 59-F-AS | CMS | 17.6% | 22.4 | 102/15 | 75 |
| | Westvaco | | | | |
| 59-G-AS | SSZ-13 | 30.4% | 22.8 | 102/15 | 75 |
| | w/w 59-1 | | | | |

| | |
|---|---|
| Common | 70 C. solution/15 mil knife/92 C. hot plate/ |
| Conditions | 30 s evap/water pptn 30 min/1 rinse i-PrOH 30 min |
| | Dried overnight before convection oven |
| | Post-treated in cell with Sylgard 3-1753 |

Asymmetric film samples were made with P84 polyimide and standard SSZ-13 (un-washed), then tested with CO₂, He, and N₂ pure gases at about 50 psi and ambient temperature, and with CO₂/CH₄ mixed gases (10% CO₂, 315 psia) at 35° C. The results are given in Table 4.

TABLE 4
P84 MMC Membrane Permeance and Selectivity

| | N2 at 160 psi, | | | | |
|---|---|---|---|---|---|
| | other gases ˜50 psig | | | 10% mixed gas | |
| | Ambient temperature | | | 35 C. | 50 C. |
| Sample # | He GPU | He/N₂ | CO2 GPU | CO₂/CH₄ | CO₂/CH₄ |
| 41-1-1 | 79 | >100 | 14 | | |
| 41-3-1 | 59 | 41 | | | |
| 41-3-2 | 90 | >100 | | 66 | 50 |
| 41-4-1 | 33 | 16 | | | |
| 41-4-2 | | | | 53 | 40 |

By comparison, neat P84 dense film membrane samples tested under the same conditions as used for the data of Table 4 showed that the He/N₂ selectivity of 129 and CO₂/CH₄ selectivity of 47 at 35° C. Surprisingly, MMC P84 asymentric film membranes show an improved CO₂/CH₄ selectivity over the P84 dense film membranes.

Asymmetric film samples were also made with standard SSZ-13 (un-washed), water-washed SSZ-13, Ultem-sized SSZ-13, SAPO-34, and CMS (Westvaco), then tested with CO₂/N₂ mixed gas (10 and 20% CO₂, about 220 psia) at 50° C. The results are given in Table 5.

TABLE 5
P84 MMC CO₂ Permeance and Selectivity With Mixed Gas

| | | Feed | | | | |
|---|---|---|---|---|---|---|
| | Mol sieve | Press. | stage | | | CO2 |
| Sample | material | psig | cut | CO₂ feed | CO2/N2 | GPU |
| 41-2-1 | SSZ-13 | 235 | 0.23% | 20.00% | 24.6 | 13 |
| 59-D-AS-1 | SAPO-34 | 230 | 0.34% | 10.60% | 20.2 | 9 |
| 48-A-AS-1 | Ultem-sized | 230 | 0.58% | 10.60% | 17.8 | 12 |
| | SSZ13 | | | | | |
| 59-E-AS-1 | Washed | 234 | 0.60% | 10.60% | 22.9 | 13 |
| | SSZ-13 | | | | | |
| 59-F-AS-1 | CMS | 234 | 0.06% | 10.60% | 25.5 | 6 |
| 59-G-AS-1 | Washed | 237 | 0.49% | 10.60% | 27.4 | 49 |
| | SSZ-13 | | | | | |
| 59-G-AS-2 | Washed | 237 | 0.84% | 10.60% | 28.7 | 78 |
| | SSZ-13 | | | | | |

By comparison, P84/H-SSZ-13 neat dense film membranes show CO₂/N₂ selectivity at 50° C. of about 17-19. Thus, P84/H-SSZ-13 asymmetric film coupons showed surprising and significant CO₂/N₂ selectivity improvement compared to neat dense film membranes. The P84 MMC asymmetric film improvement ranged from 27 to 60% over P84 neat dense films. This improvement is similar to or better than those reported for MMC dense films (approximately 40% higher compared to the dense neat polymer film).

The samples of Table 5 also show that useful MMC membranes based on P84 matrix polymers can be prepared with various aluminosilicate, silico-alumino-phosphate and carbon based molecular sieve materials. Some coupons were affected by defects; however, approximately half of all coupons surprisingly showed significant selectivity improvements approaching or exceeding those reported for MMC dense films.

P84-based asymmetric MMC films were also prepared with Ultem-sized SSZ-13, SAPO-34, and CMS sieve material. Though all SSZ-13 samples were APDMS-silanated, apparently, P84-based MMC films do not require additional sizing for acceptable adhesion. The single P84-CMS coupon showed promising results.

Hydrocarbon Exposure Tests

Testing also shows that P84 MMC membranes are resistant to decreased performance, due to interactions with hydrocarbons. A P84/SSZ-13 MMC asymmetric film was tested with 10% CO₂ in CH₄ at 50° C. and 315 psia. The film had a CO₂ permeance of 4 GPU and CO₂/CH₄ selectivity of 50. The film was then exposed to 10% CO₂+10% n-butane in CH₄ at 50° C. and 150-200 psig for 4 days. The film's performance was measured again with 10% CO₂ in CH₄ at 50° C. and 315 psia. The asymmetric film performance was unchanged.

Although the present invention has been described in considerable detail with reference to certain preferred versions and examples thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

1. A membrane for fluid separation comprising:
a) a molecular sieve material; and
b) a polyimide polymer, wherein said polyimide polymer comprises a plurality of first repeating units of a formula (I), wherein said formula (I) is: 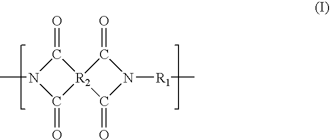
in which R₁ of said formula (I) is a moiety having a composition selected from the group consisting of a formula (A), a formula (B), a formula (C), and mixtures thereof, wherein said formula (A), said formula (B), and said formula (C) are: 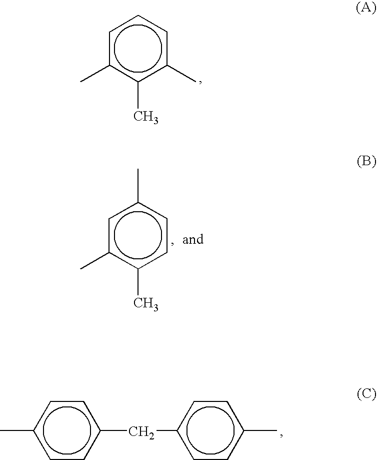
and in which R₂ of said formula (I) is a moiety having a composition selected from the group consisting of a formula (Q), a formula (S), a formula (T), and mixtures thereof, wherein said formula (Q), said formula (S), and said formula (T) are: 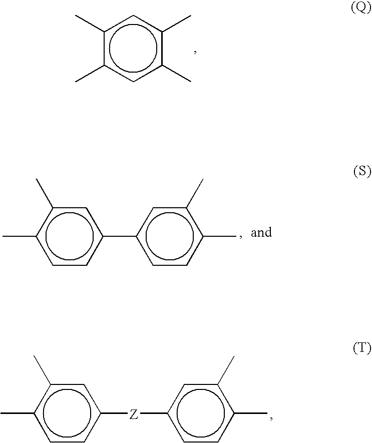
in which Z of said formula (T) is a moiety having a composition selected from the group consisting of a formula (L), a formula (M), a formula (N), and mixtures thereof, wherein said formula (L), said formula (M), and said formula (N) are:

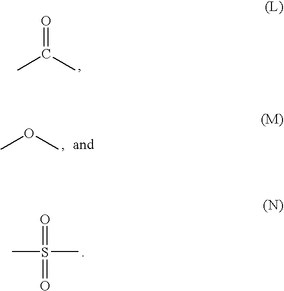

2. The membrane of claim 1, wherein said first repeating units comprise moieties of a formula (Ia), wherein said formula (Ia) is: 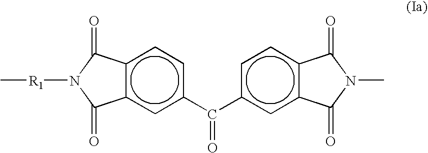
wherein R₁ of formula (Ia) is a moiety selected from the group consisting of said formula (A), said formula (B), said formula (C), and mixtures thereof.

3. The membrane of claim 2, wherein said moiety R₁ has a composition of:
a) said formula (A) in about 10-25% of said first repeating units;
b) said formula (B) in about 55-75% of said first repeating units; and
c) said formula (C) in about 20-40% of said first repeating units.

4. The membrane of claim 3, wherein said moiety R₁ has a composition of:
a) said formula (A) in about 16% of said first repeating units;
b) said formula (B) in about 64% of said first repeating units; and
c) said formula (C) in about 29% of said first repeating units.

5. The membrane of claim 1, wherein said first repeating units comprise moieties of a formula (Ib), wherein formula (Ib) is: 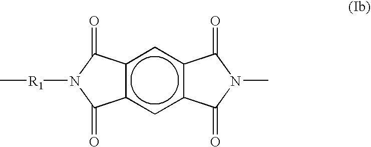
wherein said R₁ of formula (Ib) is a moiety is a moiety selected from the group consisting of said formula (A), said formula (B), and mixtures thereof.

6. The membrane of claim 1, wherein said first repeating units comprise moieties of:
a) a formula (Ia); and
b) a formula (Ib); and
wherein said formula (Ia) and said formula (Ib) are: 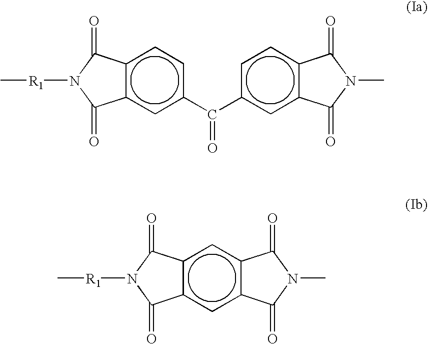
and wherein R₁ is a moiety selected from the group consisting of said formula (Q), said formula (S), and mixtures thereof.

7. The membrane of claim 6, wherein R₁ is a moiety having a composition of:
a) said formula (A) in about 10-30% of said first repeating units; and
b) said formula (B) in about 70-90% of said first repeating units; and
wherein said first repeating units of said formula (Ib) are about 30-50% of the total of said first repeating units.

8. The membrane of claim 7, wherein R₁ is a moiety having a composition of:
(a) said formula (A) in about 20% of said first repeating units; and
(b) said formula (B) in about 80% of said first repeating units, and
wherein said first repeating units of said formula (Ib) are about 40% of the total of said first repeating units.

9. The membrane of claim 1, wherein said membrane comprises in a range of about 20 to about 90% by weight said polyimide polymer.

10. The membrane of claim 9, wherein said polyimide polymer is selected from the group consisting of P84 polymer, P84-HT polymer, annealed P84 polymer, annealed P84 polymer, and mixtures thereof.

11. The membrane of claim 1, wherein said molecular sieve material is selected from the group consisting of aluminosilicate molecular sieve, silicalite molecular sieve, silico-alumino-phosphate molecular sieve, alumino-phosphate molecular sieve, carbon-based molecular sieve, and mixtures thereof.

12. The membrane of claim 11, wherein said membrane comprises in a range of about 10 to about 20 percent by weight said molecular sieve material.

13. The membrane of claim 12, wherein said molecular sieve material is an SSZ-13 molecular sieve material.

14. The membrane of claim 13, wherein said SSZ-13 sieve material is selected from the group consisting of a calcinated SSZ-13 sieve material, an organosilicon treated SSZ-13 sieve material, and mixtures thereof.

15. The membrane of claim 14, wherein said polyimide polymer is selected from the group consisting of P84 polymer, P84-HT polymer, annealed P84 polymer, annealed P84 polymer, and mixtures thereof.

16. The membrane of claim 15, wherein said membrane is an asymmetric film membrane.

17. A method of producing a fluid separation membrane, said method comprising the steps of:
(a) providing a polyimide polymer comprising:
i) a molecular sieve material; and
(b) a polyimide polymer, wherein said polyimide polymer comprises a plurality of first repeating units of a formula (I), wherein said formula (I) is: 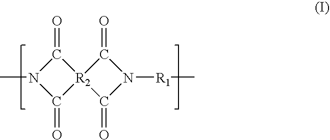
in which R₁ of said formula (I) is a moiety having a composition selected from the group consisting of a formula (A), a formula (B), a formula (C), and mixtures thereof, wherein said formula (A), said formula (B), and said formula (C) are: 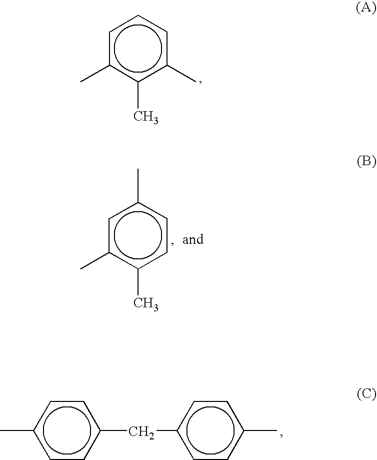
and in which R₂ of said formula (I) is a moiety having a composition selected from the group consisting of a formula (Q), a formula (S), a formula (T), and mixtures thereof, wherein said formula (Q), said formula (S), and said formula (T) are: 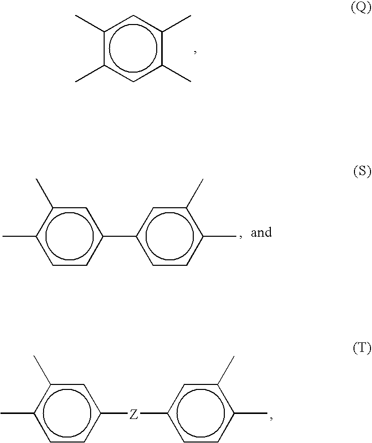
in which Z of said formula (T) is a moiety having a composition selected from the group consisting of a formula (L), a formula (M), a formula (N), and mixtures thereof, wherein said formula (L), said formula (M), and said formula (N) are: 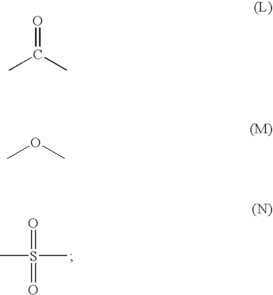
(c) providing a molecular sieve material;
(d) synthesizing a concentrated suspension, wherein said concentrated suspension comprises a solvent, said polyimide polymer, and said molecular sieve material; and
(e) forming a membrane.

18. The method of claim 17, wherein said polyimide polymer is selected from the group consisting of P84 polymer, P84-HT polymer, annealed P84 polymer, annealed P84 HT polymer, and mixtures thereof, and wherein said molecular sieve material is an SSZ-13 molecular sieve material.

19. The method of claim 18, wherein said SSZ-13 molecular sieve material is selected from the group consisting of a calcinated SSZ-13 sieve material, an organosilicon treated SSZ-13 sieve material, and mixtures thereof.

20. The method of claim 19, wherein said polyimide polymer is about 20 to about 25% by weight of said concentrated suspension.

21. The method of claim 20, wherein said SSZ-13 molecular sieve material is about 10 to 20% by weight of said concentrated suspension.

22. The method of claim 21, wherein said forming step forms an asymmetric film membrane.

23. The method of claim 22, further comprising the step of electrostabilizing said concentrated suspension to form a stabilized suspension before said forming step.

24. A method of separating a fluid from a fluid mixture comprising the steps of:
(a) providing a hollow fiber membrane made by the method of claim 1;
(b) contacting a fluid mixture with a first side of said membrane thereby causing a preferentially permeable fluid of said fluid mixture to permeate said membrane faster than a less preferentially permeable fluid to form a permeate fluid mixture enriched in said preferentially permeable fluid on a second side of said membrane and a retentate fluid mixture depleted in said preferentially permeable fluid on said first side of said membrane; and
(c) withdrawing said permeate fluid mixture and said retentate fluid mixture separately,
wherein the pressure gradient across said membrane is in a range of about 100 to about 2000 psi.

25. The method of claim 24, wherein said pressure gradient across said membrane is in the range of about 1000 to about 2000 psi.

26. The method of claim 24, wherein said fluid mixture comprises carbon dioxide and a gas selected from the group consisting of methane, nitrogen, and mixtures thereof.

27. The method of claim 24, wherein said fluid mixture comprises oxygen and a gas selected from the group consisting of methane, nitrogen, and mixtures thereof.

28. The method of claim 24, wherein said fluid mixture comprises helium and a gas selected from the group consisting of methane, oxygen, nitrogen, and mixtures thereof.
